(19) United States
(12) Patent Application Publication
(10) Pub. No.: US 2014/0002786 A1
(43) Pub. Date: Jan. 2, 2014

(54) DECORATIVE EYEGLASSES

(71) Applicant: Keith P. Alderson, St. Louis, MO (US)

(72) Inventor: Keith P. Alderson, St. Louis, MO (US)

(21) Appl. No.: 13/534,099

(22) Filed: Jun. 27, 2012

(51) Int. Cl. G02C 11/02

(52) U.S. Cl. 351/52

(57) ABSTRACT

A pair of eyeglasses is disclosed in which the pair of eyeglasses comprises a frame having a first lens member having an outer surface having a first color, a second lens member having an outer surface having a second color, and a bridge connecting the first lens member and the second lens member together, a first temple arm connected to the first lens member and having an outer surface having a third color, a second temple arm connected to the second lens member and having an outer surface having a fourth color, and the first color and second color being different from each other and the third color and the fourth color being different from each other.

### BACKGROUND

This disclosure relates to a pair of eyeglasses and more particularly to a pair of decorative eyeglasses having different design elements for presentation of different appearances for eyeglasses.

Eyeglasses are used by individuals to compensate for or correct various visual defects. Sunglasses are worn to shield or protect eyes from the harmful effects of ultraviolet radiation. Eyeglasses and sunglasses have evolved to become a fashion accessory that allows individuals to wear different glasses at different times. For example, some eyeglasses may be worn with formal attire while other glasses may be worn when outdoors. Although there are various glasses, there is still a need for a pair of eyeglasses that are different from any other eyeglasses. There is still a need for a pair of eyeglasses that incorporate different designs to provide a variety of looks or appearances.

Therefore, it would be desirable to have a pair of eyeglasses that provides a variety of looks based upon the various desires of the individual wearing the eyeglasses. It would also be advantageous to have a pair of eyeglasses that are completely different from other pairs of eyeglasses to allow an individual to accessorize. Further, it would be beneficial to have a pair of eyeglasses that are reconfigurable into various different appearances for an individual to have several options on the look of the eyeglasses.

### BRIEF SUMMARY

In one form of the present disclosure, a pair of eyeglasses is disclosed in which the pair of eyeglasses comprises a frame having a first lens member having an outer surface having a first color, a second lens member having an outer surface having a second color, and a bridge connecting the first lens member and the second lens member together, a first temple arm connected to the first lens member and having an outer surface having a third color, a second temple arm connected to the second lens member and having an outer surface having a fourth color, and the first color and second color being different from each other and the third color and the fourth color being different from each other.

In another form of the present disclosure, a pair of eyeglasses is disclosed in which the pair of eyeglasses comprises a frame having a first lens member having an outer surface having a first design, a second lens member having an outer surface having a second design, and a bridge connecting the first lens member and the second lens member together, a first temple arm connected to the first lens member and having an outer surface having a third design, and a second temple arm connected to the second lens member and having an outer surface having a fourth design, and the first design.

In yet another form of the present disclosure, a pair of eyeglasses is disclosed in which the pair of eyeglasses comprises a frame having a first lens member having an outer surface having a first design, a second lens member having an outer surface having a second design, and a bridge connecting the first lens member and the second lens member together, a first temple arm connected to the first lens member and having an outer surface having a third design and an inner surface having a fourth design, and a second temple arm connected to the second lens member and having an outer surface having a fifth design and an inner surface having a sixth design.

In light of the foregoing comments, it will be recognized that a principal object of the present disclosure is to provide a pair of eyeglasses having different design elements.

A further object of the present disclosure is to provide a pair of eyeglasses which is of simple construction and design and which can be easily employed with highly reliable results.

Another object of the present disclosure is to provide a pair of eyeglasses that is capable of presenting various appearances or looks.

A still further object of the present disclosure is to provide a pair of eyeglasses that can be used by an individual as an accessory.

A further object of the present disclosure is to provide a pair of eyeglasses that can incorporate various interchangeable members to present various different appearances without the need to purchase other eyeglasses.

Another object of the present disclosure is to provide a pair of sunglasses that has different design elements or colors.

Yet another object of the present disclosure is to provide a pair of eyeglasses that has a combination of different designs, patterns, or colors incorporated into the eyeglasses.

These and other advantages of the present disclosure will become apparent after considering the following detailed specification in conjunction with the accompanying drawings, wherein:

### BRIEF DESCRIPTION OF THE DRAWINGS

FIG. 1 is a perspective view of a pair of eyeglasses constructed according to the present disclosure;

FIG. 2 is a perspective view of a pair of eyeglasses constructed according to the present disclosure;

FIG. 3 is a perspective view of a pair of eyeglasses constructed according to the present disclosure;

FIG. 4 is a perspective view of a pair of eyeglasses constructed according to the present disclosure;

FIG. 5 is a perspective view of a pair of eyeglasses constructed according to the present disclosure;

FIG. 6 is a perspective view of a pair of eyeglasses constructed according to the present disclosure;

FIG. 7 is a perspective view of another embodiment of a pair of eyeglasses constructed according to the present disclosure;

FIG. 8 is a perspective view of a pair of eyeglasses constructed according to the present disclosure; and

FIG. 9 is a perspective view of another embodiment of a pair of eyeglasses constructed according to the present disclosure.

### DETAILED DESCRIPTION OF PREFERRED EMBODIMENTS

Referring now to the drawings, wherein like numbers refer to like items, number 10 identifies a preferred embodiment of a pair of eyeglasses constructed according to the present disclosure. With reference now to FIG. 1, the pair of eyeglasses 10 is shown to comprise a frame 12 having a first lens member 14 having an outer surface 16, a second lens member 18 having an outer surface 20, and a bridge 22 connecting the first lens member 14 and the second lens member 18 together. Supported and captured in the first lens member 14 is a lens or eyeglass 24 and in the second lens member 18 is a lens or eyeglass 26. As can be appreciated, the lenses 24 and 26 may be sunglass lenses. A first temple arm or member 28 is connected to the first lens member 14 and has an outer surface 30. A second temple arm or member 32 is connected to the second lens member 18 and has an inner surface 34. The second temple arm 32 also has an outer surface, however, such outer surface is not depicted in FIG. 1. Also, the first temple arm 28 has an inner surface which is not shown in FIG. 1. The first temple arm 28 and the second temple arm 32 may be connected to the first lens member 14 and the second lens member 18, respectively, in any suitable or conventional manner. For example, a hinge can be used to connect the first temple arm 28 to the first lens member 14. The pair of eyeglasses 10 may be constructed from any suitable material such as plastic, composite material, metal, or nylon.

As will be explained in more detail herein, the first lens member 14 may comprise a first color, design, or pattern, the second lens member 18 may comprise a second color, design, or pattern, the first temple member 28 may comprise a third color, design, or pattern, and the second temple member 32 may comprise a fourth color, design, or pattern. As can be appreciated, the various colors, designs, or patterns may be completely different from each other providing a mixed up appearance or look. By way of example only, it is possible that the first lens member 14 may have a first color, the second lens member 18 may have a second color, the first temple member 28 may have the same color as the second lens member 18, and the second temple member 32 may have the same color as the first lens member 14. In this particular arrangement, a discontinuous or opposite appearance is provided.

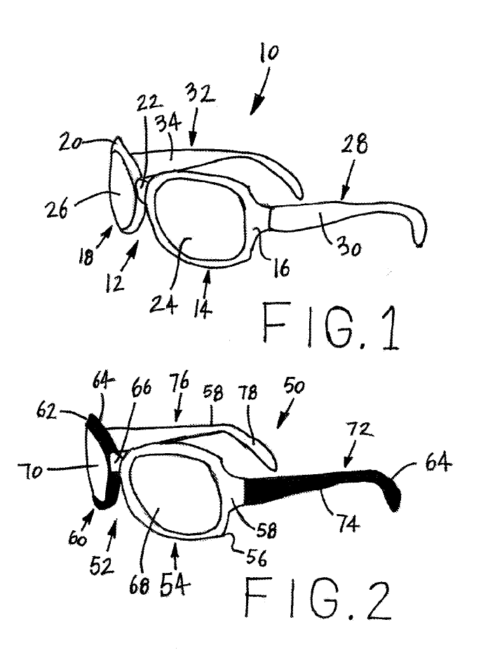

With reference now to FIG. 2, a perspective view of another pair of eyeglasses 50 is shown. The pair of eyeglasses 50 comprises a frame 52 having a first lens member 54 having a surface 56 having a first color 58, such as the color white. The frame 52 also has a second lens member 60 having a surface 62 having a second color 64, such as the color black. A bridge 66 is provided which connects the first lens member 54 and the second lens member 60 together. The bridge 66 may have a color that is different than the first color 58 and the second color 64. It is also contemplated that the bridge 66 may be half of the first color 58 and half of the second color 64 to present a split look or appearance. Positioned within the first lens member 54 is a first lens 68 and positioned within the second lens member 60 is a second lens 70. A first temple arm or member 72 is connected to the first lens member 54 and has a surface 74 having the second color 64. A second temple arm or member 76 is connected to the second lens member 60 and has a surface 78 having the first color 58. In this manner, opposite colors 58 and 64 are presented.

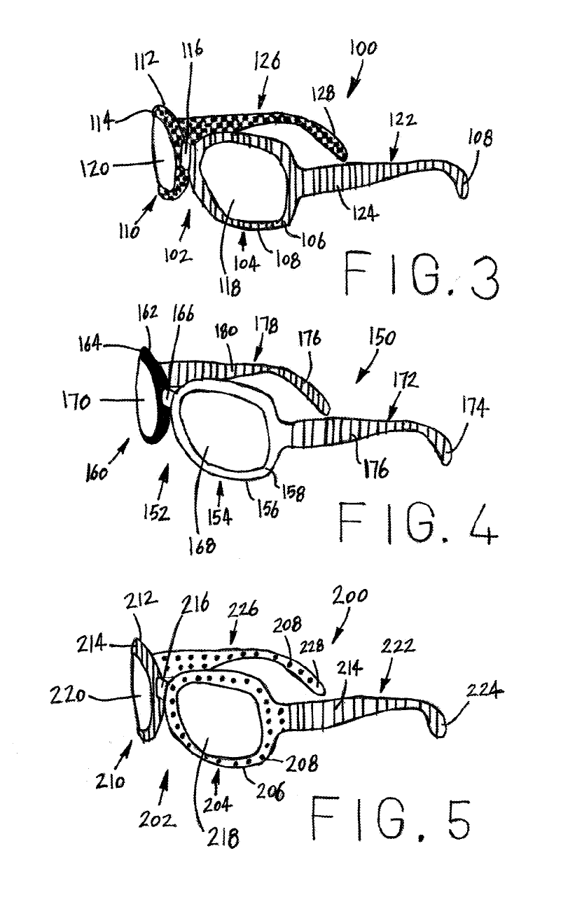

FIG. 3 illustrates another pair of eyeglasses 100 constructed according to the present disclosure. The pair of eyeglasses 100 comprises a frame 102 having a first lens member 104 having a surface 106 having a first pattern 108, such as the a striped pattern. The frame 102 also has a second lens member 110 having a surface 112 having a second pattern 114, such as a diamond pattern. A bridge 116 is provided which connects the first lens member 104 and the second lens member 110 together. The bridge 116 may have a pattern or a color that is different than the first pattern 108 and the second pattern 114. Positioned within the first lens member 104 is a first lens 118 and positioned within the second lens member 110 is a second lens 120. The lenses 118 and 120 may be the same color or different colors. By way of example, if the pair of eyeglasses 100 is a pair of sunglasses then the lenses 118 and 120 may have a mirrored surface to reflect ultraviolet radiation. The mirrored surfaces may have a color coating and the color coating for each of the lenses 118 and 120 may be the same or different. A first temple arm 122 is connected to the first lens member 104 and has a surface 124 having the first pattern 108. A second temple arm 126 is connected to the second lens member 110 and has a surface 128 having the second pattern 114. In this manner, the pair of eyeglasses 100 appears to be one half of one pair of eyeglasses provided by the first pattern 108 and a second half of a different pair of eyeglasses provided by the second pattern 114 Also, in this particular embodiment, the first pattern 108 may be one color and the second pattern 114 may be a different color.

Referring now to FIG. 4, another pair of eyeglasses 150 constructed according to the present disclosure is depicted. The pair of eyeglasses 150 comprises a frame 152 having a first lens member 154 having a surface 156 having a first color 158, such as the color white. The frame 152 also has a second lens member 160 having a surface 162 having a second color 164, such as the color black. A bridge 166 is provided which connects the first lens member 154 and the second lens member 160 together. Positioned within the first lens member 154 is a first lens 168 and positioned within the second lens member 160 is a second lens 170. The lenses 168 and 170 may be the same color or different colors. A first temple arm 172 is connected to the first lens member 154 and has a surface 174 having a first pattern 176, such as a stripped pattern. A second temple arm 178 is connected to the second lens member 160 and has a surface 180 having the first pattern 176. In this particular embodiment, the pattern 176 consists of colors, such as black and white, and the same colored pattern 176 is resident on both of the temple arms 172 and 178. The pair of eyeglasses 150 appears to have a first lens member 154 of one color and a second lens member 160 of a different color, and a pair of temple arms 172 and 178 of the same colored pattern. The bridge 166 may have the same pattern as the pattern 176, or the color 158, or the color 164, or a completely different color. As can be appreciated, the lenses 168 and 170 may be the same color which may be different than the color 158 or the color 164.

FIG. 5 is an illustration of another pair of eyeglasses 200. The pair of eyeglasses 200 are shown to comprise a frame 202 having a first lens member 204 having a surface 206 having a first pattern 208, such as a pattern of dots. The first pattern 208 may consist of two colors, such as the dots being one color and the background being a second color. The frame 202 also has a second lens member 210 having a surface 212 having a second pattern 214, such as a stripped pattern. The second pattern 214 may consist of two colors, such as the stripe being a third color and the background color being a fourth color. The first, second, third, and fourth colors may be different from each other. A bridge 216 is provided which connects the first lens member 204 and the second lens member 210 together. The bridge 216 may be a color such as the first color, or the second color, or the third color, or the fourth color. It is also possible and contemplated that the bridge 216 may be one of the patterns 208 or 214. Positioned within the first lens member 204 is a first lens 218 and positioned within the second lens member 210 is a second lens 220. The lenses 218 and 220 may be the same color or different colors. A first temple arm 222 is connected to the first lens member 204 and has a surface 224 having the second pattern 214. A second temple arm 226 is connected to the second lens member 210 and has a surface 228 having the first pattern 208. The pair of eyeglasses 200 appears to have the first lens member 204 having one pattern and the second lens member 210 having a different pattern, the temple arm 222 opposite the lens member 210 having the same pattern 214, and the temple arm 226 opposite the lens member 204 having the same pattern 208.

With particular reference now to FIG. 6, a pair of eyeglasses 250 is shown constructed according to the present disclosure. The pair of eyeglasses 250 comprises a frame 252 having a first lens member 254 having a surface 256 having a first color 258, such as by way of example only the color blue. The frame 252 also has a second lens member 260 having a surface 262 having a second color 264, such as the color red. A bridge 266 is provided which connects the first lens member 254 and the second lens member 260 together. Positioned within the first lens member 254 is a first lens 268 and positioned within the second lens member 260 is a second lens 270. The lenses 268 and 270 may be the same color or different colors. A first temple arm 272 is connected to the first lens member 254 and has a surface 274 having a first pattern 276, such as a number of stripes 278. The stripes 278 of the pattern 276 are the same color as the second color 264. In this example, the stripes 278 of the pattern 276 are red and the background color of the pattern 276 may be white. A second temple arm 280 is connected to the second lens member 260 and has a surface 282 having the first pattern 276. However, the stripes 284 of the pattern 276 on the second temple arm 280 are the same color as the first color 258. For reference, the stripes 284 are blue and the background may be white, which is the same background color as the pattern 276 on the first temple arm 272. In this particular embodiment, the pair of eyeglasses 250 presents an appearance having the first lens member 254 of one color, the second lens member 260 of a different color, the first temple arm 272, which is opposite the second lens member 260, having a pattern having the same color as the second lens member 260, and the second temple arm 280, which is opposite the first lens member 254, having a pattern having the same color as the first lens member 254.

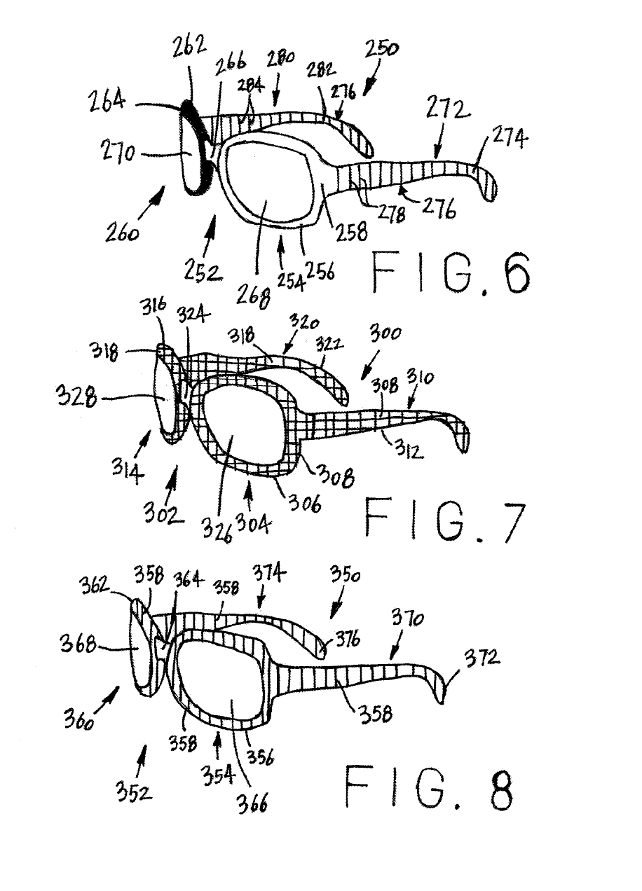

FIG. 7 is an illustration of a pair of eyeglasses 300. The pair of eyeglasses 300 comprises a frame 302 having a first lens member 304 having a surface 306 having a first pattern 308, such as a plaid pattern. The first pattern 308 may consist of various colors. A first temple arm 310 is connected to the first lens member 304 and has a surface 312 having the first pattern 308 with the colors being the same as the first pattern on the first lens member 304. The frame 302 also has a second lens member 314 having a surface 316 having a second pattern 318, such as a plaid pattern. In this particular embodiment, the first pattern 308 is the same as the second pattern 318. The second pattern 318 may consist of various colors which are different than the colors in the first pattern 308. A second temple arm 320 is connected to the second lens member 314 and has a surface 322 having the second pattern 318 with the colors being the same as the second pattern 318 on the second lens member 314. A bridge 324 is provided which connects the first lens member 304 and the second lens member 314 together. Positioned within the first lens member 304 is a first lens 326 and positioned within the second lens member 314 is a second lens 328. The lenses 326 and 328 may be the same color or different colors. The pair of eyeglasses 300 appears to have one half a first colored pattern and another half as a different color pattern with the patterns being the same.

Referring now to FIG. 8, another pair of eyeglasses 350 is depicted. The pair of eyeglasses 350 comprises a frame 352 having a first lens member 354 having a surface 356 having a pattern 358, such as a stripped pattern. The stripped pattern 358 may consists of a pair of colors such as blue and white. The frame 352 also has a second lens member 360 having a surface 362 having the pattern 358. However, in this particular case, the colors of the pattern 358 on the second lens member 360 are different than the colors on the first lens member 354. By way of example only, the colors on the second lens member 360 may be green and red. A bridge 364 is provided which connects the first lens member 354 and the second lens member 360 together. Positioned within the first lens member 354 is a first lens 366 and positioned within the second lens member 360 is a second lens 368. The lenses 366 and 368 may be the same color or different colors. A first temple arm 370 is connected to the first lens member 354 and has a surface 372 having the pattern 358. The colors of the pattern 358 on the first temple arm 370 are the same colors in the pattern on the second lens member 360. Again, in this example such colors are green and red. A second temple arm 374 is connected to the second lens member 360 and has a surface 376 having the pattern 358 thereon. As can be appreciated, the colors of the pattern 358 on the second temple arm 374 are the same colors in the pattern on the first lens member 354. For the sake of consistency, such colors are blue and white. The pair of eyeglasses 350 in this particular embodiment presents an appearance having the same pattern 358 throughout with opposite colors on the first lens member 354 as compared to the second lens member 360, and opposite colors the first temple arm 370 as compared to the second temple arm 374.

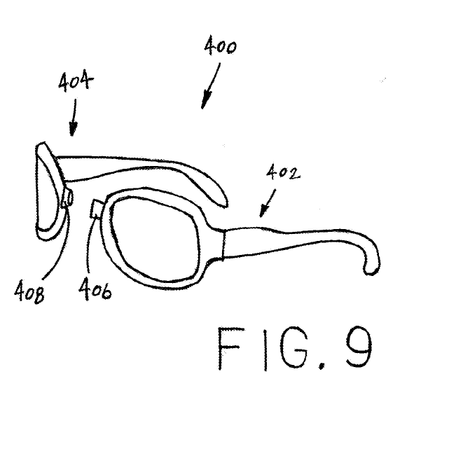

FIG. 9 illustrates another embodiment of a pair of eyeglasses 400 constructed according to the present disclosure. The pair of eyeglasses 400 shows how the pair 400 can be disassembled into a first half 402 and a second half 404. In this particular arrangement, the pair 400 has a first bridge portion 406 which may engage a second bridge portion 408. The first bridge portion 406 may have a larger diameter than the second bridge portion 408 and the second bridge portion 408 may be inserted into the first bridge portion 406 to connect the first half 402 to the second half 404. As can be appreciated, the first half 402 and the second half 404 may take on any of the colors, designs, patterns, or characteristic described above with reference to the eyeglasses 10, 50, 100, 150, 200, 250, 300, and 350. The eyeglasses 10, 50, 100, 150, 200, 250, 300, and 350 can be mixed and matched to present various different appearances.

Although not described in detail, it is possible that the eyeglasses 10, 50, 100, 150, 200, 250, 300, 350, and 400 disclosed herein may have various other shapes, sizes, patterns, designs, and colors. It is also possible that the eyeglasses 10, 50, 100, 150, 200, 250, 300, 350, and 400 may have other structure not discussed. For example, a nose support, hinges, and springs may be incorporated into any of the eyeglasses disclosed herein.

From all that has been said, it will be clear that there has thus been shown and described herein a pair of eyeglasses which fulfills the various advantages sought therefore. It will become apparent to those skilled in the art, however, that many changes, modifications, variations, and other uses and applications of the subject pair of eyeglasses are possible and contemplated. All changes, modifications, variations, and other uses and applications which do not depart from the spirit and scope of the disclosure are deemed to be covered by the disclosure, which is limited only by the claims which follow.

What is claimed is:

1. A pair of eyeglasses comprising:
a frame having a first lens member having an outer surface having a first color, a second lens member having an outer surface having a second color, and a bridge connecting the first lens member and the second lens member together;
a first temple arm connected to the first lens member and having an outer surface having a third color;
a second temple arm connected to the second lens member and having an outer surface having a fourth color; and
the first color and second color being different from each other and the third color and the fourth color being different from each other.

2. The pair of eyeglasses of claim 1 wherein the bridge has an outer surface having a fifth color.

3. The pair of eyeglasses of claim 1 wherein the first color is the same as the fourth color.

4. The pair of eyeglasses of claim 1 wherein the second color is the same as the third color.

5. The pair of eyeglasses of claim 1 wherein the first color is the same as the second color.

6. The pair of eyeglasses of claim 1 wherein the third color is the same as the fourth color.

7. The pair of eyeglasses of claim 1 further comprising a first lens mounted in the first lens member having a first lens color and a second lens mounted in the second lens member having a second lens color.

8. A pair of eyeglasses comprising:
a frame having a first lens member having an outer surface having a first design, a second lens member having an outer surface having a second design, and a bridge connecting the first lens member and the second lens member together;
a first temple arm connected to the first lens member and having an outer surface having a third design; and
a second temple arm connected to the second lens member and having an outer surface having a fourth design.

9. The pair of eyeglasses of claim 8 wherein the first design is a first pattern and the second design is a second pattern and the first pattern is different than the second pattern.

10. The pair of eyeglasses of claim 8 wherein the first design is a plaid pattern.

11. The pair of eyeglasses of claim 8 wherein the first design and the third design are the same.

12. The pair of eyeglasses of claim 8 wherein the second design and the fourth design are the same.

13. The pair of eyeglasses of claim 8 further comprising a first lens mounted in the first lens member having a first lens color and a second lens mounted in the second lens member having a second lens color.

14. A pair of eyeglasses comprising:
a frame having a first lens member having an outer surface having a first design, a second lens member having an outer surface having a second design, and a bridge connecting the first lens member and the second lens member together;
a first temple arm connected to the first lens member and having an outer surface having a third design and an inner surface having a fourth design; and
a second temple arm connected to the second lens member and having an outer surface having a fifth design and an inner surface having a sixth design.

15. The pair of eyeglasses of claim 14 wherein the third design and the fourth design are different from each other.

16. The pair of eyeglasses of claim 14 wherein the fifth design and the sixth design are different from each other.

17. The pair of eyeglasses of claim 14 wherein the third design and the fifth design are the same.

18. The pair of eyeglasses of claim 14 wherein the fourth design and the sixth design are the same.

19. The pair of eyeglasses of claim 14 wherein the first design is a pattern.

20. The pair of eyeglasses of claim 14 wherein the first design is a color.
